(19) United States
(12) Patent Application Publication
(10) Pub. No.: US 2015/0316666 A1
(43) Pub. Date: Nov. 5, 2015

(54) Efficient Similarity Search of Seismic Waveforms

(71) Applicant: The Board of Trustees of the Leland Stanford Junior University, Palo Alto, CA (US)

(72) Inventors: Gregory C. Beroza, Palo Alto, CA (US); Ossian J. O'Reilly, Stanford, CA (US); Clara E. Yoon, Sunnyvale, CA (US); Karianne Bergen, Stanford, CA (US)

(21) Appl. No.: 14/704,387

(22) Filed: May 5, 2015

Related U.S. Application Data
(60) Provisional application No. 62/046,871, filed on Sep. 5, 2014.
(60) Provisional application No. 61/988,580, filed on May 5, 2014.

(51) Int. Cl. G01V 1/00; G01V 1/30

(52) U.S. Cl. CPC G01V 1/008; G01V 1/30; G01V 2210/1232

(57) ABSTRACT

Detection of repeating seismic events from long duration seismic data without prior knowledge of event waveforms is performed by computing compact binary fingerprints from seismic data, generating a similarity matrix from the fingerprints, and identifying seismic events from the similarity matrix, e.g., using a thresholding condition. Each element of the similarity matrix is a value representing similarity between a pair of fingerprints, where the value is calculated by hashing fingerprints to hash buckets in multiple hash tables and counting a fraction of the multiple hash tables containing a fingerprint match in the hash buckets. The similarity matrix may be combined with similarity matrices derived from other seismic data to produce a total network similarity matrix, increasing the sensitivity of the detection. Other seismic data may include multiple components recorded at a single station or data recorded at separately located stations.

### CROSS-REFERENCE TO RELATED APPLICATIONS

This application claims priority from U.S. Provisional Patent Application 61/988,580 filed May 5, 2014, which is incorporated herein by reference. This application claims priority from U.S. Provisional Patent Application 62/046,871 filed Sep. 5, 2014, which is incorporated herein by reference.

### FIELD OF THE INVENTION

The present invention relates generally to techniques for analysis of seismic data. More specifically, it relates to techniques for monitoring and detection of seismic events such as earthquakes.

### BACKGROUND OF THE INVENTION

Earthquake detection is the foundation for many studies in observational seismology. Earthquake catalogs contain a database of the latitude, longitude, depth, origin time, and magnitude for every earthquake detected from seismograms recorded by at least 4 stations. These catalogs, however, are complete only to a certain minimum magnitude. Seismic events of smaller magnitude escape detection using standard techniques and are missing from the catalog. Thus, it remains a challenge to improve earthquake monitoring by detecting more earthquakes from massive volumes of continuous waveform data across a seismic network, especially those that cannot be found with existing detection methods.

In standard earthquake monitoring, an earthquake is independently detected by individual stations using an energy-based detection technique such as Short Term Averaging/Long Term Averaging (STA/LTA). Given a seismogram, STA/LTA computes the ratio of the short-term average (STA) power in a short window to the long-term average (LTA) power in a longer window as these windows slide through the waveform data. A detection is declared when the ratio STA/LTA exceeds a predetermined threshold. For example, FIG. 1A shows a portion of a seismogram with arrival time picks as vertical lines, FIG. 1B shows an envelope function of the seismogram with STA and LTA windows, and FIG. 1C shows a smoothed STA/LTA ratio with threshold as dashed line. After events are detected independently at separate stations, an association algorithm then determines if detections at multiple stations across the network are consistent with a seismic source.

STA/LTA successfully detects earthquakes with impulsive, high signal-to-noise ratio (SNR) P and S wave arrivals, and can be used widely without prior knowledge of the event waveform or source information. However, STA/LTA fails to detect earthquakes, or may produce false detections, in various situations: 1) low SNR, 2) waveforms with non-impulsive, emergent arrivals, 3) if many earthquakes overlap in time, 4) competing cultural noise sources, and 5) sparsely recorded earthquakes—such as at only one station. Low-frequency earthquakes (LFEs) are hard to find because of 1) and 2), aftershocks and swarms are missing from catalogs because of 3), and potentially induced seismicity is poorly characterized because of 5). Many interesting seismological phenomena, absent from current catalogs, lie dormant in continuous waveform data, waiting to be discovered.

Researchers have attempted to overcome some limitations of STA/LTA energy-based detectors. Because seismic events that repeat in time, over a period of several years, are observed to have very similar waveforms when recorded at the same station, waveform cross-correlation can, in principle, exploit waveform similarity to provide more sensitive earthquake detection.

Waveform cross-correlation, also called matched filtering or template matching, can detect a known seismic signal in noisy data. It is a “one-to-many” search method that cross-correlates a template waveform vᵢ with the signal of interest, with successive candidate time windows wᵢ(t) of continuous waveform data, computing their normalized correlation coefficient, CC(t):

$$CC ( t ) = \frac{{\sum }_{i = 1}^{N} {v}_{i} {w}_{i} ( t )}{\sqrt{{\sum }_{i = 1}^{N} {v}_{i} {v}_{i}} \sqrt{{\sum }_{i = 1}^{N} {w}_{i} ( t ) {w}_{i} ( t )}} \qquad Eq . 1$$

where t is the start time of each candidate window in the continuous data. The value CC(t) ranges between −1 and 1; any candidate window wᵢ(t) that results in a CC(t) spike above some threshold is considered similar enough to the template waveform to call it a detection.

Template matching can be improved by using templates that include waveforms from multiple channels and stations. Detection is based on the network correlation coefficient, computed from CC(t) summed over all channels and stations.

Template matching is a versatile technique that has been applied to a wide range of seismicity studies. Waveform cross correlation for detection has also been used for nuclear monitoring and discrimination, as well as microseismic monitoring in geothermal fields and oil and gas reservoirs.

However, a major limitation of template matching is that it requires an a priori waveform template. It is thus unable to detect new unknown events with low SNR repeating signals. It remains an open problem to detect signals with similar waveforms in continuous data without any prior knowledge of the desired signal.

When the form of a desired signal is not known, autocorrelation can be used to perform an exhaustive, “many-to-many” search for a similar signal. The seismic signals of interest are known to have short duration (earthquake waveforms are usually a few seconds long on each channel), so the continuous data is partitioned into short overlapping windows, and every window is cross-correlated with every other window of the continuous data. Window pairs with CC(t) exceeding a detection threshold are marked as candidate events, which can then be post-processed with an additional cross-correlation on pairs of candidate events, or grouped into families and stacked to form less noisy template waveforms.

However, autocorrelation is computationally intensive, and ultimately infeasible for massive data sets because autocorrelation scales quadratically with data duration. Autocorrelation is also very sensitive to timing, so the time lag between adjacent windows in the continuous data needs to be short, which makes the number of windows large.

While autocorrelation can be feasible to detect similar seismic signals that span an hour of continuous data, it becomes completely impractical if the seismogram signals span days, weeks, months, or years.

In summary, standard energy detectors currently used in earthquake monitoring fail to find events when the signal-to-noise ratio is low or many events overlap in time. Waveform cross-correlation is capable of detecting such missing events, especially when the desired signal is known in advance. But finding an unknown repeating earthquake signal with waveform cross-correlation is computationally infeasible for long data durations. Thus, there remains a need for improved techniques for detecting seismic events.

### SUMMARY OF THE INVENTION

The present inventors have discovered a computationally scalable solution to find unknown repeating seismic events. Through a unique combination of techniques such as data compression, discriminative feature extraction, locality-sensitive hashing, and similarity matrices, it is capable of detecting uncataloged earthquakes in long durations of continuous waveform data with dramatic improvements in computational efficiency compared with standard autocorrelation techniques. The approach is further improved through the combined use of three components of seismic data and an innovative technique for combining data measured by multiple sensors in a network.

In one aspect, the present invention provides a method to efficiently search massive continuous seismic station or network data to find seismic signals (e.g., earthquakes) that repeat or have similar waveforms. The method does not require a priori knowledge of any template waveforms, but is based instead on the assumption that similar sources have similar waveform signatures. Also provided is an over-network approach that finds similar waveforms over a distributed network of sensors using an algorithm to incorporate and combine data from seismic stations at different locations in the network.

Embodiments of the technique use waveform feature extraction to develop a compact description of seismic signals. After feature extraction, waveforms with similar features are grouped together using hashing techniques. This technique for earthquake detection uses the fact that similar seismic sources will result in similar waveform signatures over a sensor network to detect earthquakes of all sizes without a priori knowledge of their characteristics. The technique works for individual sensors, and it may also be implemented over a network of sensors.

Because it enables practical detection of events that have remained undetected using prior techniques, the invention solves a long-standing need for better information on what seismic sources are triggered—either intentionally or unintentionally—through energy (oil, gas, and geothermal) development. It also answers a need for improved earthquake monitoring in areas where earthquakes may be induced by human actions.

In one aspect, the invention provides a method for identifying seismic events. The method includes recording by a seismic sensor, extracting a sequence of overlapping time windows from the continuous time series data, and generating from each of the overlapping time windows a fingerprint to produce a sequence of fingerprints corresponding to the sequence of overlapping time windows. From each of the fingerprints a set of multiple hash signatures is generated using multiple distinct locality-sensitive hash functions to produce a sequence of hash signature sets corresponding to the sequence of fingerprints. For each of the hash signature sets, a set of corresponding hash buckets in distinct hash tables of a hash database is selected, where one or more of the multiple distinct locality-sensitive hash functions corresponds to each of the distinct hash tables. For each of the hash signature sets and corresponding fingerprint, a number of hash tables containing a matching fingerprint in the selected set of corresponding hash buckets is counted, to produce a similarity matrix whose elements represent similarity between pairs of overlapping time windows of the continuous time series data representative of seismic activity. Seismic events are then identified from the similarity matrix.

In some embodiments, seismic events are identified from the similarity matrix by combining the similarity matrix with similarity matrices derived from continuous time series data representative of seismic activity recorded at other seismic sensors to produce a network similarity matrix, and identifying seismic events from the network similarity matrix by applying a detection threshold. The matrices are preferably added by only adding nonzero elements and only adding lower (or, alternatively, upper) triangular elements, thereby making addition more computationally efficient because the matrices are sparse and symmetric.

In preferred embodiments, the fingerprint from each of the overlapping time windows is generated by calculating wavelet coefficients of a spectrogram of each of the overlapping time windows. In some embodiments, the fingerprint from each of the overlapping time windows is generated by combining fingerprints derived from continuous time series data representative of three components of seismic activity, one vertical, two horizontal.

The technique has a number of advantages: It is computationally efficient, does not require prior information on the nature of the seismic source, and can take advantage of entire sensor networks to enable detection at lower signal-to-noise ratios.

The invention has applications to earthquake monitoring, from the global scale to the scale of energy (oil, gas) reservoirs, geothermal power production fields, and wastewater disposal wells. It has applications to the oil and gas industry, finding previously unknown seismic sources during hydraulic fracturing operations, waste-water disposal, and during production. It has applications to the geothermal power industry, finding previously unknown seismic sources, particularly during active time periods when one or more sources may be active. It has applications to carbon sequestration, monitoring for possible failure of reservoir integrity that manifests itself through seismic waves. It has applications to earthquake and volcano monitoring more generally, finding sources that were not previously detected, particularly during periods of high activity.

### BRIEF DESCRIPTION OF THE DRAWINGS

FIGS. 1A-C are graphs illustrating the conventional STA/LTA earthquake detection algorithm, showing a seismogram with arrival time picks as vertical lines (FIG. 1A), an envelope function of seismogram with STA and LTA windows (FIG. 1B), and smoothed STA/LTA ratio with threshold as dashed line (FIG. 1C).

FIG. 2 is an overview of a signal-processing pipeline illustrating the construction of a search database from seismic waveform data, according to an embodiment of the invention.

FIG. 3 is a graph illustrating overlapping windows extracted from the time series seismic data, according to an embodiment of the invention.

FIGS. 4A-B illustrate an example of a 1D Haar discrete wavelet transform, showing both the decomposition of data into wavelet coefficients (FIG. 4A) and the reconstruction of the original data (FIG. 4B), as applied to a data processing pipeline according to an embodiment of the invention.

FIG. 5A is an overview of a similarity search in a database for waveforms matching a query waveform, where a measure of similarity is given by a fraction of hash tables in which each matching waveform is found, according to an embodiment of the invention.

FIG. 5B illustrates feature extraction steps, according to an embodiment of the invention.

FIG. 5C is an example of how a database is created using locality-sensitive hashing, according to an embodiment of the invention.

FIG. 6 is a graph of probability of successful search versus Jaccard similarity for different numbers of hash tables, according to an embodiment of the invention.

FIG. 7 is a log-log graph of extrapolated runtime as a function of waveform data duration, based purely on scaling properties, comparing autocorrelation on 1 processor, autocorrelation on 1000 processors, and fingerprinting with similarity search according to an embodiment of the invention.

FIG. 8 illustrates a data processing pipeline for fingerprint generation for multiple channels of data from the same station, where wavelet transformed images from multiple channels are combined to form one image, from which a single binary fingerprint is generated, according to an embodiment of the invention.

FIG. 9 illustrates a channel similarity matrix used for seismic event detection, where the value of each element of the matrix represents a similarity between two fingerprints derived from waveforms at two times, according to an embodiment of the invention.

FIG. 10A illustrates a data processing pipeline for detecting seismic events from data collected from multiple stations, where each station generates a channel similarity matrix and the event detection is based on total network similarity matrix obtained by adding together the channel similarity matrices from multiple stations, according to an embodiment of the invention.

FIG. 10B illustrates an example of a total network similarity matrix calculation for two similar waveforms (and therefore fingerprints) at different times, recorded across multiple stations, according to an embodiment of the invention.

FIG. 11 illustrates a total network similarity matrix obtained by adding together the channel similarity matrices from multiple stations, where the dark regions correspond to similar fingerprints indicative of repeating seismic events, according to an embodiment of the invention.

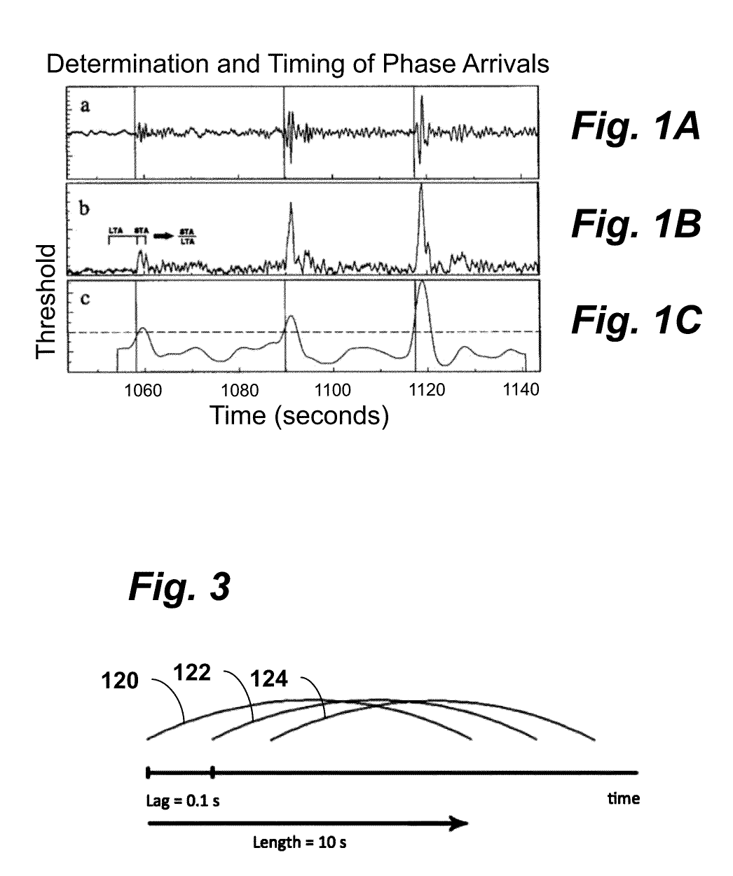

### DETAILED DESCRIPTION

Embodiments of the invention efficiently find similar seismic signals without prior knowledge of their form. First, seismic waveform data measured by seismic sensors is preprocessed to extract short overlapping time windows. The data preferably includes one vertical and two horizontal components, each of which is processed. Next, key discriminative features are extracted from each window to create its fingerprint, i.e., a compact proxy that identifies a window of seismic data. A database of fingerprints is created using locality-sensitive hashing (LSH). Given a query seismic waveform, its fingerprint is calculated and hashed to efficiently identify all other fingerprints in the database that resemble it. Each row of the symmetric similarity matrix represents the results of the hash-based matching between the database of hashed fingerprints and the hashed fingerprint of the query seismic waveform; the rows and columns of the similarity matrix represent the same fingerprints.

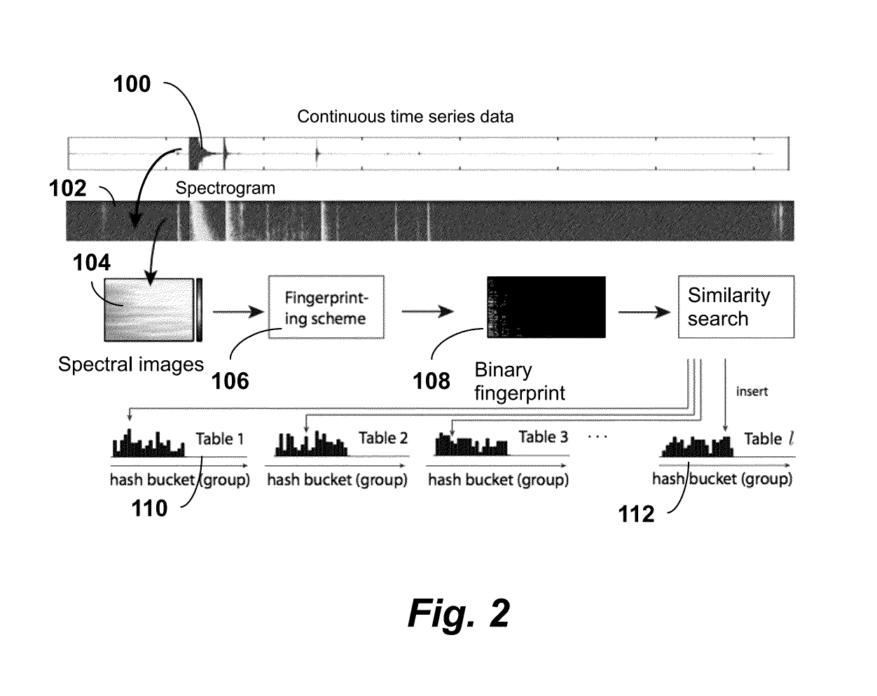

FIG. 2 is a functional block diagram illustrating an overview of this approach. The preprocessing step selects time series seismic data 100 and removes noise, then computes its spectrogram 102 and segments it into overlapping spectral images 104. The feature extraction step computes the Haar wavelet transform of each spectral image and applies data compression to form a binary fingerprint 106. Applying LSH to the fingerprints produces hash signatures that are stored in a database, placing a reference to each fingerprint in one hash bucket 110 through 112 of each hash table. A query seismic data waveform is processed in the same way, and the hash buckets for each of its windows are determined. A similarity matrix is computed, where each entry in the row of the matrix corresponding to the query sample represents a similarity between the query sample and a window in the stored database. The value of a matrix element for a pair of windows is derived from a number of matches between the hash buckets derived from the two windows. These steps will now be described in more detail.

### Data Selection and Preprocessing

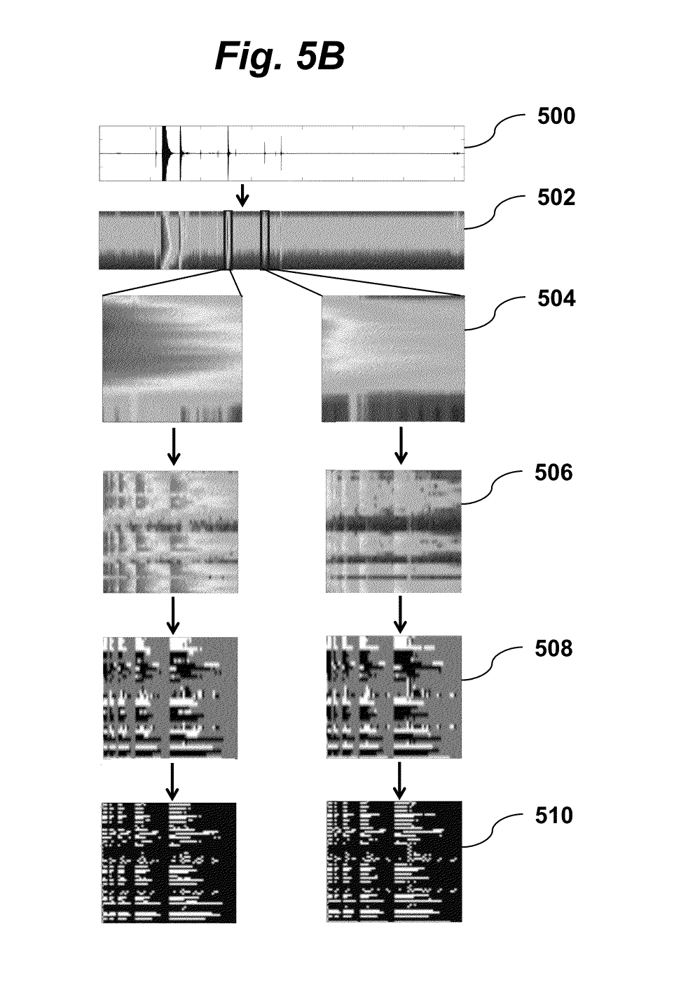

The feature extraction steps are illustrated in FIG. 5B, which includes continuous time series data 500, corresponding spectrogram 502 (amplitude on log scale), spectral images 504 from two similar earthquakes at different times, Haar wavelet coefficients 506 (amplitude on log scale), sign of top z-score deviation Haar coefficients after data compression 508, and binary fingerprint 510 which is the output of feature extraction. These steps will now be described in more detail.

Using standard seismic sensor equipment, continuous waveform data 500 is recorded at a station for hours, days, weeks, or longer. The data includes the vertical component, and preferably also includes two horizontal components as well. The amplitude of the data can have a large dynamic range, which is the reason why earthquake magnitudes are measured with a logarithmic scale. A bandpass filter is preferably applied to the data to help eliminate effects of correlated noise at lower frequencies, which may interfere with the ability to detect the uncataloged earthquakes; the passband should exclude the frequency range of noise in the data channel, which is specific to the station. The filtered data is decimated from its original sampling rate of 100 sps to 20 sps, so that the Nyquist frequency is 10 Hz. The decimation should downsample the data to the lowest possible frequency while ensuring that the Nyquist frequency remains above the frequency range of the expected seismic signals. Sampling rates from 20 to 100 sps are typical for seismic network data.

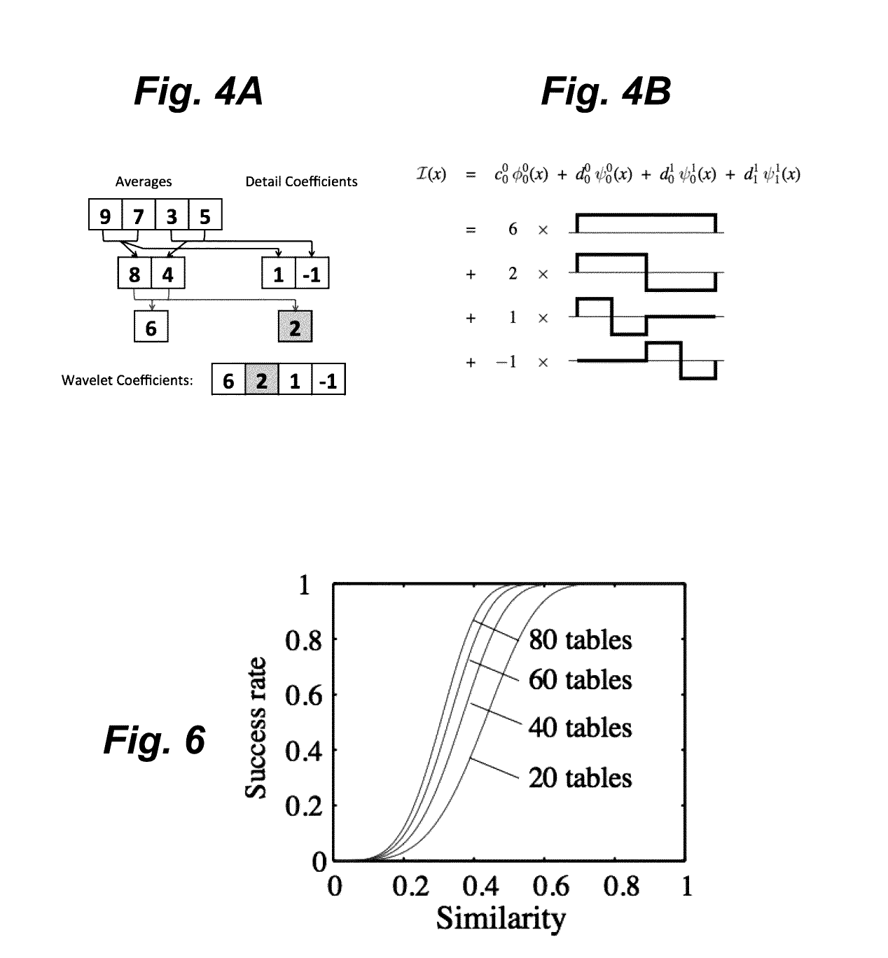

After filtering and decimating the time series data, the technique computes its spectrogram 502, which consists of intensity values for each frequency and time, using the short-time Fourier transform. Specifically, overlapping time windows in the continuous time series, separated by some lag, are extracted, a Hamming tapering function is applied to each window, and the FFT of each window is computed. As an illustrative example, shown in FIG. 3, overlapping windows 120, 122, 124 have length of 10 seconds and lag 0.1 s between adjacent windows. This corresponds to 200 samples and 2 samples, respectively, given the 20 sps sampling rate. Preferably, the window length is between 5 s and 20 s, depending on characteristics of the desired seismic signals. For short duration, high-frequency signals recorded at short distances that change quickly, 5 s is better, while for longer, low-frequency signals that change more gradually and are recorded at greater distances, 20 s is better. Preferably, the window lag should range from 0.05 s to 1 s; its shortest possible value is determined by the sampling rate as 1/(20 sps)=0.05 s. The lag should be shorter than the window length, and there should be enough overlap between adjacent windows so that the spectrogram varies slowly in time. The spectrogram is then downsampled to 32 frequency bins, which enables faster processing and smoothes away some noise. 16 or 64 are also reasonable values for the number of frequency bins in the spectrogram, which needs to be a power of 2.

In order to facilitate comparison and detection of short duration seismic signals, the spectrogram 502 is itself divided into overlapping windows in the time dimension. Each of these windows is referred to as a spectral image 504. The spectral window length L_{fp} and spectral window lag τ_{fp} for spectral images may be, for example, L_{fp}=100 samples and τ_{fp}=10 samples, respectively. A shorter spectral image lag increases detection sensitivity and timing precision, at the expense of additional runtime. Since the time window lag for spectrogram generation was 0.1 s, L_{fp}=(100 samples)*(0.1 s/sample)=10 s, and τ_{fp}=(10 samples)*(0.1 s/sample)=1 s. Preferably, L_{fp} should range from 5 s for small, short duration earthquakes, to 20 s for larger earthquakes with longer duration; L_{fp} should be long enough to include the entire seismic signal waveform of interest, but not longer—otherwise, noise also enters the window, which degrades the shape of the waveform. Preferably, τ_{fp} should range from 0.5 s to 2 s; its minimum value would be 0.1 s (1 sample), but this is inefficient. An empirical rule for choosing τ_{fp} would be 5-20 samples.

The total number of spectral image windows, and ultimately the number of fingerprints N_{fp}, is:

$${N}_{fp} = ⌊ \frac{{N}_{t} - ( {L}_{fp} - {τ}_{fp} )}{{τ}_{fp}} ⌋ \qquad Eq . 2$$

where Nₜ is the number of time samples in the spectrogram. For example, N_{fp}=604,781 windows, for 1 week of data sampled at 20 sps, with spectrogram time window lag=2 samples, L_{fp}=100 samples, and τ_{fp}=10 samples.

Because the spectrogram content varies slowly with time, we can find similar seismic signals even with a longer spectral image lag. The 1 s spectral image time lag is much longer than the 0.1 s lag used in time series autocorrelation, which contributes to fast performance of our detector: fewer spectral images from the same continuous data, and fewer fingerprints to first calculate and then compare for similarity.

Although the spectral image length is 10 s in this example, this does not directly correspond to 10 s of waveform data, but instead includes more information. The first time sample in the spectral image contains 10 s of waveform data from the time series, converted to its frequency content. The second time sample in the spectral image contains data from 0.1 s to 10.1 s—with an extra 0.1 s of data at the end, since the lag between windows for spectrogram generation was 0.1 s. The third time sample has data from 0.2 s to 10.2 s, and so on. Since the spectral image has L_{fp}=100 time samples, the 100^{th} sample has data from 9.9 s to 19.9 s. Therefore, the spectral image actually contains content from 19.9 s of waveform data.

Preferably, to prepare the data for a recursive wavelet transform, each spectral image is downsampled to the highest power of 2 less than the current number of samples in the time dimension. (We already downsampled in frequency to 2⁵=32.) Since we started with 100 samples in the time domain, we downsample to 2⁶=64 samples. At the end, each spectral image has dimensions 32 samples by 64 samples.

### Wavelet Transform

In the next stage of the processing pipeline, a two-dimensional Haar wavelet transform of each spectral image 504 is computed to obtain its wavelet coefficient representation 506. This facilitates lossy data compression, while remaining robust to small noise perturbations. Wavelets are a mathematical tool for multi-resolution analysis: they hierarchically decompose data into its overall average shape, plus successive levels of detail describing deviations from the average shape, from coarsest to finest resolution. A discrete wavelet transform (DWT) has different kinds of basis functions (one example is the Haar basis), is localized in both the time and frequency domains, and can express nonstationary, burst-like signals (such as earthquakes) using only a few wavelet coefficients.

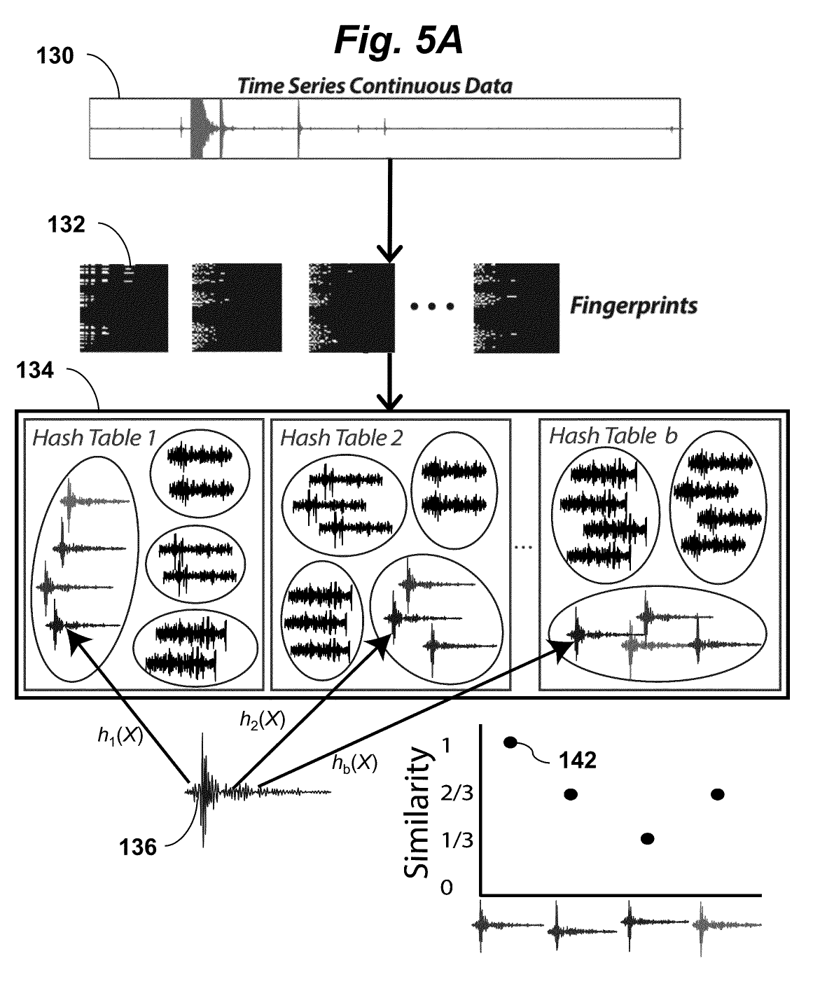

In general, a DWT recursively transforms data to wavelet coefficients, which makes the algorithm fast. In the 1D case, at each recursive step, the average between two adjacent numbers in the data is computed, then the “detail coefficients”, or the difference between the first number in each pair and the average, are computed until only one average value remains. FIG. 4A shows an example, where 1D data has 4 elements: (9, 7, 3, 5). The wavelet coefficients are stored in the following order: first the average value (6), then the detail coefficients in order of coarsest (2) to finest (1, −1). The simplest wavelet basis is the Haar basis: a series of square waves with different resolutions. FIG. 4B shows how to multiply the wavelet coefficients (6, 2, 1, −1) by the Haar basis functions to get the original data I(x)=(9, 7, 3, 5). The DWT can also be computed with other wavelet basis functions that are continuous, such as the Daubechies basis functions of different orders, but the runtime is longer than for the Haar basis.

Computing a 2D Haar wavelet transform involves calculating the recursive average and detail coefficients in two dimensions. The generalization from 1D to 2D is well known in the art.

### Data Compression and Binary Fingerprint

The technique provides a compact, diagnostic representation of the original spectral image that can identify similar seismic signals and discriminate between seismic signals and noise. The technique keeps only a fraction of the total Haar wavelet coefficients that best retain key discriminative features of the original spectral image, and discards the rest. Earthquake signals constitute a small percentage of the continuous data, since most of it is noise, so we expect representative Haar wavelet coefficients for earthquakes to strongly deviate from those of noise. To maximize the discriminative value of the Haar coefficients, we retain the top k Haar coefficients with the largest deviation from their typical values. The size of the deviation for a given Haar coefficient is quantified using a standardized score, or z-score, based on the empirical distribution of that coefficient over the data set.

To obtain Haar coefficient z-scores, we first take the Haar coefficients for all spectral image windows and place them in a M×N matrix we call H, where M=32*64=2048 Haar coefficients (since each spectral image had dimensions 32*64), and N=N_{fp}=604,781 spectral images. We normalize each column (Haar coefficients from one spectral image) of the matrix, dividing by its L2 norm. Then for each row i of the matrix, we compute the mean μᵢ and standard deviation σᵢ for Haar coefficient i, over all windows j:

$${μ}_{i} = \frac{1}{N} {\sum }_{j = 1}^{N} {H}_{ij} \\ {σ}_{i} = \sqrt{\frac{1}{N - 1} {\sum }_{j = 1}^{N} {( {H}_{ij} - {μ}_{i} )}^{2}} \qquad Eq . 3$$

The z-score for each Haar coefficient i and window j is then

$${Z}_{ij} = \frac{{H}_{ij} - {μ}_{i}}{{σ}_{i}} \qquad Eq . 4$$

The z-score distribution has zero mean and unit standard deviation. Adding more continuous data, and therefore more Haar coefficients from spectral image windows, would change μᵢ, σᵢ, and consequently the z-score distribution.

Preferably, the predetermined threshold is k=800 (out of 32×64=2048) coefficients with the highest amplitude z-scores, which corresponds to just under 40% of all the coefficients. Reasonable values for k are 200-800; higher values are not recommended because the resulting fingerprints would no longer be sparse.

Furthermore, the wavelet coefficient z-score amplitudes can be reduced to only their signs: +1 for positive coefficients, −1 for negative coefficients, and 0 for the discarded coefficients to obtain a compressed wavelet coefficient representation 508. This provides additional data compression, capturing the main characteristics of the image in compact form while remaining robust to noise degradation.

The final feature extraction step is to generate the binary fingerprint 510 from the top amplitude wavelet coefficient z-score signs. The fingerprint is represented in binary so that the Min-Hash and LSH algorithms may be used for efficient similarity search. The following encoding scheme may be used to represent each of the top wavelet coefficients as a two-bit binary sequence: Negative coefficients are represented by 01, Zero is represented by 00, Positive coefficients are represented by 10. At this point, each spectral image is thus represented by a binary fingerprint 510.

A measured continuous data waveform thus produces a large collection of fingerprints: sparse, compact items that characterize the spectral images extracted from the time series waveform data.

To enable scalable search for similar earthquake signals, fingerprints are grouped into hash buckets, and comparisons between fingerprints (or their original waveforms) are limited to those in a matching hash bucket group. In a preferred embodiment, similar fingerprints are grouped together using Min-Hash and LSH algorithms. Using this technique, the similarity search time for N fingerprints increases near-linearly with data duration. In contrast, the corresponding O(N²) complexity of autocorrelation similarity search is practically infeasible for large N.

### Database Generation

As described earlier, template matching and autocorrelation techniques use the correlation coefficient CC(t) in Eq. 1 to measure how similar two waveforms are. However, CC(t) is not an ideal metric to evaluate similarity of two binary fingerprints, which can only have 0 or 1 values. Instead, embodiments of the present invention preferably compare two binary fingerprints using the Jaccard similarity as a similarity metric. Jaccard similarity J(A,B) for two binary fingerprints A and B is defined as

$$J ( A , B ) = \frac{\vert A ⋂ B \vert}{\vert A ⋃ B \vert} \qquad Eq . 5$$

The numerator contains the number of elements where both A and B are equal to 1, while the denominator counts elements where either A, B, or both A and B are equal to 1.

In a preferred embodiment, an algorithm called Min-Wise Independent Permutation (Min-Hash) is used to further reduce dimensionality of each binary fingerprint from a 4096-element bit vector to a shorter integer array. Min-Hash uses several random hash functions h(X), where each hash function maps a sparse, binary, high-dimensional fingerprint X to one integer, h(X). Min-Hash has the important property that the probability of two fingerprints A and B mapping to the same integer is equal to their Jaccard similarity:

Pr[h(A)=h(B)]=J(A,B) Eq. 6

Thus, Min-Hash reduces dimensionality in a probabilistic manner, while preserving the similarity between fingerprints A and B.

The output of Min-Hash is an array of p unsigned integers called a Min-Hash Signature (MHS), given a sparse binary fingerprint as input. The MHS estimates the Jaccard similarity by counting all of the matching integers from the MHS of both A and B, and then dividing by p. As p increases, the estimate of the Jaccard similarity improves. The p Min-Hash functions are constructed by drawing p×4096 (4096 is the number of bits in a fingerprint) independent and identically distributed random samples from a uniform distribution, returned by calling any uniform hash function, to get an array r(i,j), where i=1, . . . , p, and j=1, . . . , 4096. Then, to obtain the output of a Min-Hash function hᵢ(X) for a given fingerprint X, we use the index of the k non-zero bits in the fingerprint to select k of the values r(i,j) generated previously (e.g., if we consider the first hash function h₁(X) out of all p hash functions, and the index of one of the non-zero bits in the fingerprint X is j=4, then r(1,4) is selected). Out of all the k selected values r(i,j), we select the minimum value and assign the index j that obtains the minimum as the output of the hash function hᵢ(X). We further reduce the size of the output by only keeping 8 bits, so that the number of bits of a MHS is 8p; each integer in the MHS has a value between 0 and 255. Table 1 shows an example of MHS arrays for two similar fingerprints A and B—notice that the MHS are almost the same.

TABLE 1

| Fingerprint A | Fingerprint B |
|---|---|
| 155 | 155 |
| 64 | 64 |
| 231 | 207 |
| 35 | 35 |
| 110 | 110 |
| 21 | 21 |

LSH uses the MHS to determine how to store the fingerprint in the database. The 8p bits of each MHS are partitioned into b groups with 8r bits in each group (p=b*r). The 8r bits in each of the b groups are used to generate b hash keys, where each hash key belongs to exactly one out of b hash tables. Each hash key retrieves a hash bucket, which can contain multiple values. We generate b*N_{fp} hash keys and values for each MHS from all N_{fp} fingerprints and insert all of the values into the hash buckets in the b hash tables given their corresponding hash keys. The values stored in the hash buckets are 32-bit integers, where each value is a reference that uniquely identifies a fingerprint.

For example, FIG. 5A has a schematic of a database 134 created by LSH. It has b=3 hash tables (shown as boxes), and each hash table has many hash buckets (shown as ovals in the boxes); similar earthquake signals (shown as waveforms in ovals) go into the same bucket, while noise signals congregate in other buckets. The database stores references to fingerprints in the hash buckets, rather than the fingerprints (or waveforms) themselves. Each of the N_{fp}=604,781 fingerprints is represented in some hash bucket in every hash table, so LSH produces multiple groupings of fingerprints into hash buckets.

FIG. 5C has an example of how LSH places two similar fingerprints into hash buckets (ovals) in each hash table (boxes) in the database. In the figure, A and B are two similar fingerprints (although waveforms are shown for easy visualization). The MHS of A and B are h(A)=[155, 64, 231, 35, 110, 21] and h(B)=[155, 64, 207, 35, 110, 21], respectively. In this example, the MHS for each fingerprint, which has length p=6, is divided among b=3 hash tables, so each hash table gets a different subset of the MHS from each fingerprint that is 6/3=2 integers long: the output of r=2 hash functions from Min-Hash. The r 8-bit integers in each MHS subset are concatenated into a 64-bit integer that defines the index of the hash bucket; as r increases, so does the total number of hash buckets. If the MHS subsets of A and B match exactly, then A and B go into the same hash bucket in the database; this is true in hash tables 1 and 3, where h(A)=h(B)=[155, 64], and h(A)=h(B)=[110, 21], respectively. However, in hash table 2, the MHS subsets of A and B are not equal, since h(A)=[231, 35] while h(B)=[207, 35], so A and B enter different hash buckets. LSH therefore allows two fingerprints to enter the same hash bucket, and be deemed as similar, even if they do not have exactly the same MHS. However, two fingerprints in the same hash bucket in most of the hash tables are likely to be highly similar.

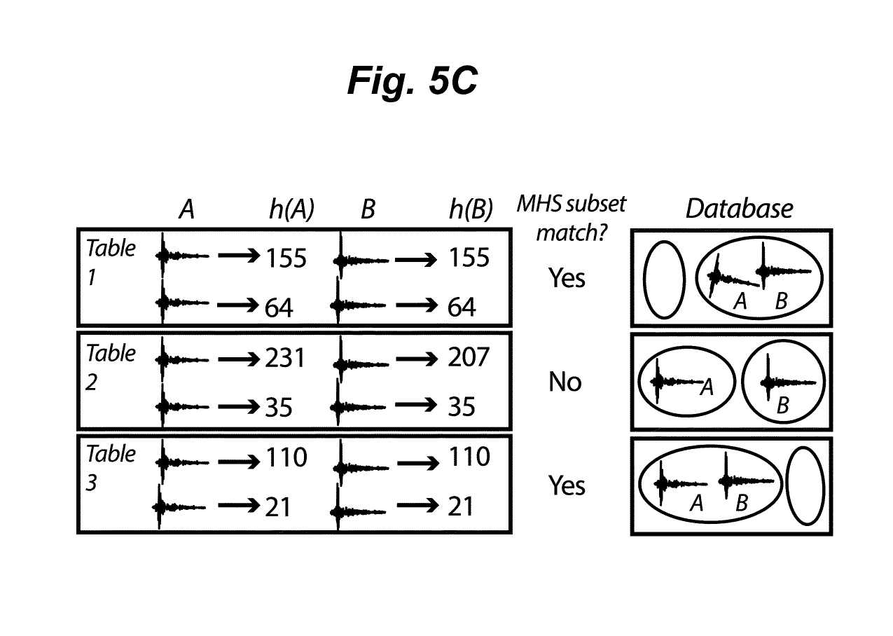

We used these LSH parameter values: r=5 hash functions per hash table to determine the hash bucket (preferably, r ranges from 1 to 8), and b=100 hash tables (preferably, b >>1), so the MHS for each fingerprint had p=5*100=500 integers. If r is too low, we have a small number of hash buckets, so each bucket may have too many fingerprints, which would increase the runtime to search for similar fingerprints, as well as the number of false detections. If r is too high, fingerprints would be spread thin among too many hash buckets, so we may miss detections if similar fingerprints end up in different hash buckets. Increasing b improves the probability of finding two fingerprints in the same bucket even if they are only slightly similar (as shown in FIG. 6), at the expense of increased memory requirements, search runtime, and false detections.

### Similarity Search Using Database

FIG. 5A provides an overview of similarity search for matching fingerprints in a database. As described above, the database is constructed by processing continuous time series data 130 to obtain fingerprints 132. Each fingerprint is assigned to a hash bucket (shown as ovals) in each of b hash tables of a database 134 using hash functions. A query waveform 136 is processed by feature extraction to generate a fingerprint, in just the same way as the processing pipeline used to construct the database. Using the hash functions, the query fingerprint is assigned to a hash bucket in each of the b hash tables of the database 134. Within each of these b assigned hash buckets, a search is performed for matching fingerprints. For each hash table, the query fingerprint will either match a fingerprint in the query hash bucket for the table, or not. The number M≦b of hash tables having such a fingerprint match is counted. The fraction of the hash tables containing the match f_{table}=M/b is used as a similarity metric. The waveform corresponding to the most similar match 142 is selected as the most similar waveform to the query. This approach is based on the insight that for higher similarity between query and matching fingerprint, we expect that they would reside in the same hash bucket in more hash tables. To reduce the number of false detections, a voting threshold of v is used: the matching fingerprint must be present in at least v=4 tables to consider it as a possible match to the query. The value of v should be kept relatively low: preferably, the voting threshold v is no more than 10% of the number of hash tables b.

A query fingerprint will always match itself as a similar fingerprint in the database, but this trivial information is not useful. Also, we are not interested in “near-repeat” pairs where a fingerprint is reported as similar to itself, but offset by a few time samples. Therefore a “near-repeat exclusion” parameter, nᵣ=5, is used to avoid returning any fingerprint within nᵣ samples of the query fingerprint as a match.

The theoretical probability that two fingerprints hash to the same bucket (have a hash collision) in at least v out of b tables, with r hash functions per table, as a function of their Jaccard similarity s, is:

$$Pr = 1 - {\sum }_{i = 0}^{v - 1} [ ( \begin{matrix}b \\ i\end{matrix} ) {( 1 - {s}^{r} )}^{b - i} {( {s}^{r} )}^{i} ] \\ ( \begin{matrix}b \\ i\end{matrix} ) = \frac{b !}{i ! ( b - i ) !} \qquad Eq . 7$$

FIG. 6 plots Eq. 7 for different values of b. The probability always increases monotonically with similarity, but as b increases from 20 to 80, the probability of successfully finding a less similar fingerprint in the same bucket increases.

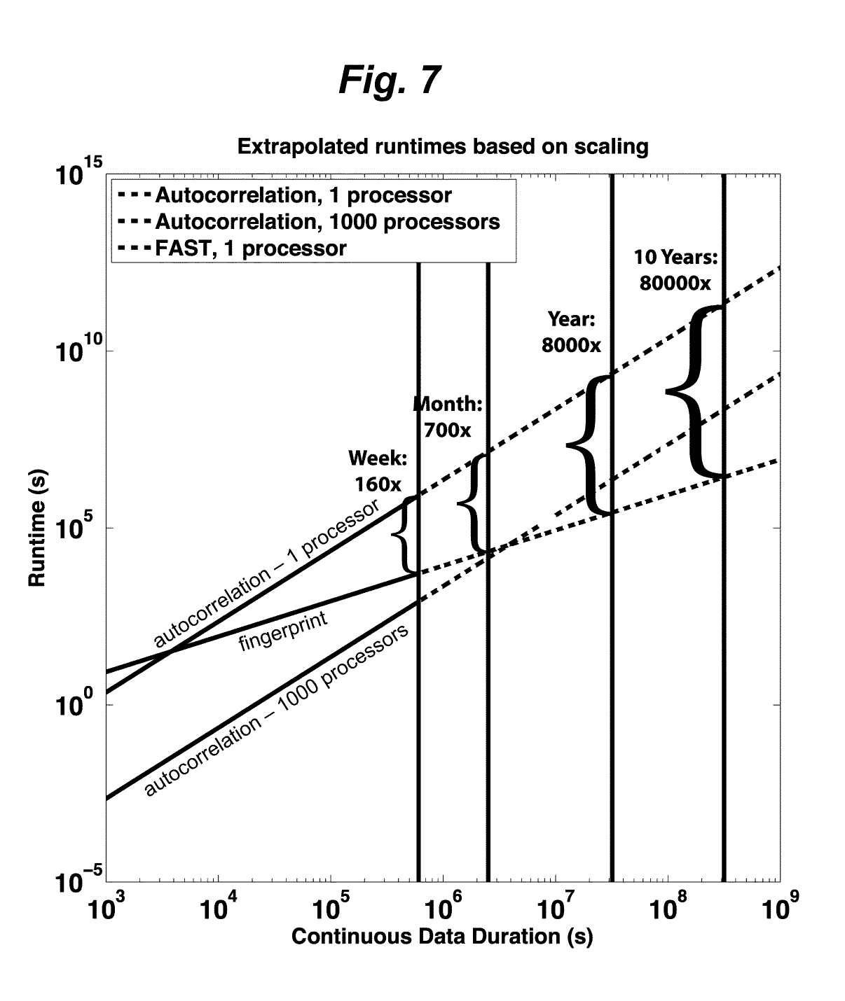

Performance of this technique is a major advance over prior techniques. As an illustration, FIG. 7 is a log-log plot of the extrapolated runtime, based purely on algorithm scaling, as a function of waveform data duration, for autocorrelation (quadratic scaling) on 1 processor, autocorrelation (quadratic scaling) on 1000 processors, and fingerprinting with similarity search (near-linear scaling) on 1 processor. For shorter durations of data autocorrelation can be feasible, but as data duration gets large (e.g., months or years) autocorrelation becomes practically impossible, even for highly parallelized computing. In contrast, fingerprinting with similarity search remains feasible for these very large durations.

### Multiple Channels

In tests by the inventors, this technique for waveform fingerprinting and similarity search can successfully detect cataloged earthquakes in single component waveform data. In addition, it also detected a significant number of uncataloged events such as aftershocks. Performance may be enhanced further by including data from other channels at the same station, allowing detection of a substantial number of additional events with even lower SNR than using one channel.

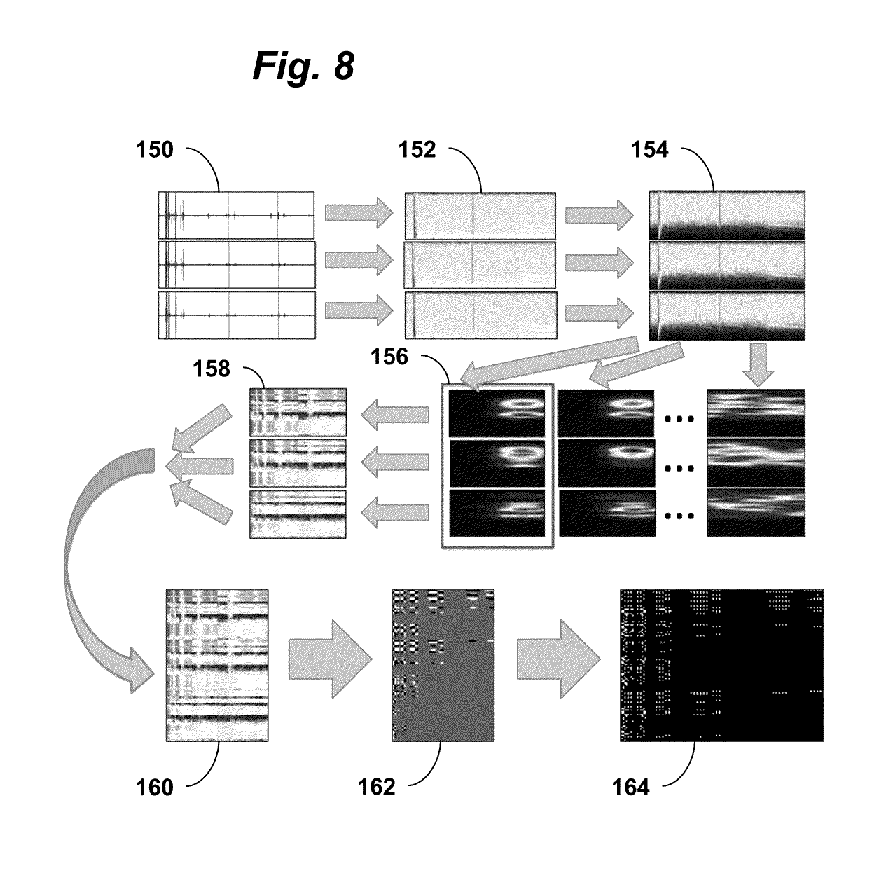

Accordingly, in some embodiments, multiple channels (components) of data are used to improve fingerprinting with efficient similarity search. FIG. 8 provides an overview of the multichannel pipeline, illustrated with an example of three channels.

Each of the three channel waveforms 150 is processed independently and in parallel, following the steps described above for one channel, to obtain three channels of spectrograms 152, three channels of filtered spectrograms 154, and three channels of spectral images 156 and three corresponding wavelet transformed images (i.e., arrays of wavelet coefficients) 158. The wavelet transformed images from the three channels are stacked (i.e., arrays are concatenated, keeping the time dimensions aligned) to get a single composite wavelet transformed image 160, having three times the frequency samples and the same number of time samples. For example, three arrays with 32 wavelet-transformed-frequency samples and 64 wavelet-transformed-time samples are combined to obtain a single array with 96 wavelet-transformed-frequency samples and 64 wavelet-transformed-time samples. Next, data compression is applied, as with the single channel case, by keeping only the top k=2400 (out of 96×64=6144) coefficients to obtain a compressed wavelet representation 162, then the binary fingerprint 164 is computed. The resulting fingerprints, which are three times as large as those from a single channel, are hashed into the database and searched in the same way to get detections. The same parameters may be used, although adjusting the values of r, b, v, and the detection threshold for f_{table} by trial and error may produce better detection performance.

### Similarity Matrix

In a preferred embodiment, detection of repeating seismic events is performed by constructing a similarity matrix for each channel. To detect similar earthquakes using one channel of continuous data, every fingerprint is used as a search query for the database, so the output of similarity search is a list of pairs of similar fingerprint indices, converted to times in the continuous data, with associated similarity values. This list of pairs can be visualized as a sparse, symmetric N_{fp}×N_{fp} similarity matrix.

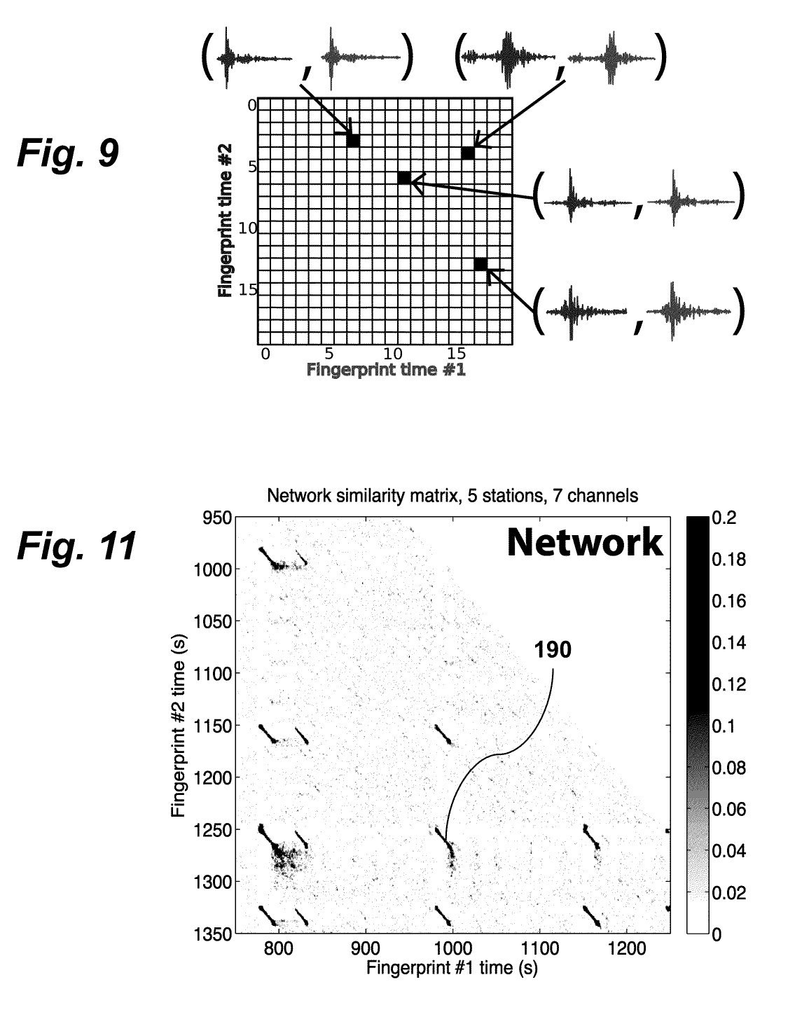

An example of a similarity matrix is shown in FIG. 9. The similarity matrix elements represent similarity between two fingerprints derived from waveforms at two different times of the continuous time series data representative of seismic activity. The matrix has rows and columns indexed by the times of the fingerprints generated from seismic data. The value of an element of the matrix is the fraction of hash tables f_{table} containing the two fingerprints in the same hash bucket, computed as described earlier.

Seismic events are identified from the similarity matrix by applying a threshold criterion for detection. The detection threshold used for 1 week of continuous data was f_{table}=0.33, meaning that the fingerprint pair needed to be present in the same hash bucket in at least 33 out of b=100 hash tables. This threshold was set by visual inspection: most pairs above the threshold looked like earthquakes, and most pairs below looked like noise. It is desirable to set the threshold to minimize both the number of false positive detections and false negative (missed) detections. The threshold value depends on the SNR of the data set; further research is required to automate the threshold calculation.

Some post-processing is required to convert a list of pairs of similar fingerprint times to a list of earthquake detection times. First, the list of pairs can have duplicate pairs with similarity above the event detection threshold of f_{table}=0.33, when they represent the same pair with slight time offsets. For example, take three pairs: (395172, 161542) with similarity 0.92, (395173, 161543) with similarity 1.00, and (395174, 161544) with similarity 0.76. Only the pair (395173, 161543) with the highest similarity 1.00 is retained; all other duplicate pairs within 21 s of the times for the highest similarity pair are removed. Next we create a list of event detection times. We sort the pairs in decreasing order of similarity, then add each event in the pair to the detection list. Sometimes we can encounter a duplicate event: for example, pair (245266 s, 1335 s) has similarity 0.79, so we add both events to the detection list, then later we have pair (1332 s, 547 s), with lower similarity 0.75. We classify the 1332 s event as a duplicate of the 1335 s event, since they are within 21 s of each other, and we do not add the 1332 s event to the list. Finally we have a list of event detections, with each event defined by its time in the continuous data in seconds, and its associated similarity. For the multiple-station case, described below, this post-processing method is applied to the network similarity matrix. The time window length used for removing duplicate pairs and events (here 21 s) should be about twice the spectral image window length (here 10 s).

### Network of Multiple Stations

Further improvements in performance are provided by embodiments in which the fingerprinting algorithm is used to process waveform data from multiple stations at distinct, but nearby, geographical locations. Combining data from multiple stations allows a unique multi-site over-network detection of repeating seismic signals with higher performance than the single-station detection. Events with even lower SNR may be detected while also keeping the number of false detections very low. Finding a coherent signal recorded at several stations located at different distances and azimuths from the source allows for better discrimination between signal and noise, and the ability to find its source location given a velocity model of the area.

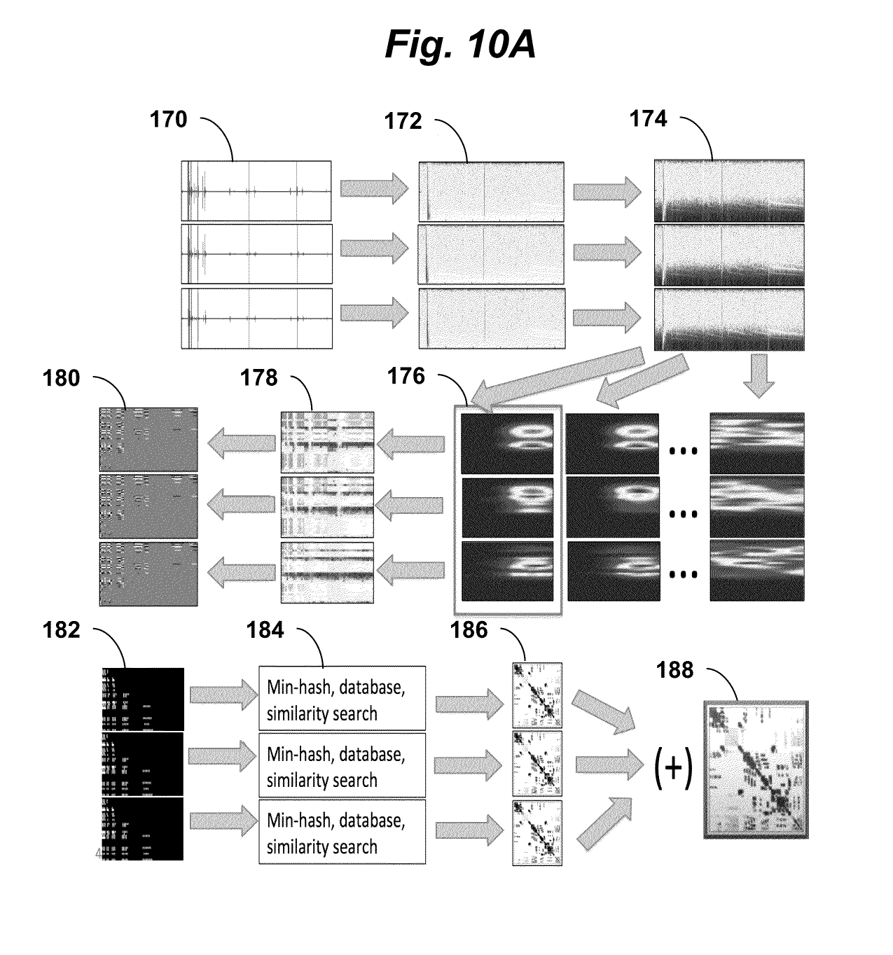

FIG. 10A shows an overview of the technique for multi-station operation, according to a preferred embodiment. Waveform data 170 for the same time period are recorded at each of multiple stations. In the example shown, three stations are illustrated. The stations are preferably within a certain distance of each other, which can range from a few meters for reservoir monitoring to 10-100 km for regional earthquake monitoring; this distance also varies with the type of sensor and the noise situation. The technique also assumes that the source of the seismic signal is located relatively close to the stations, so that the velocity moveout is small, and the signal is recorded within the same short time window at almost all stations. As described earlier in relation to other embodiments, the waveforms 170 are processed in parallel to produce spectrograms 172, filtered spectrograms 174, spectral images 176, wavelet transforms 178, compressed wavelets 180, and binary fingerprints 182. The fingerprints are hashed and the database search 184 is performed independently on each channel to produce single-channel similarity matrices 186. These steps are performed separately and independently on data from each station. Seismic events are identified by combining the similarity matrix of a single site with similarity matrices derived from continuous time series data representative of seismic activity recorded at other sites to produce a network similarity matrix 188. These sparse matrices 186 are preferably added by only adding nonzero elements and only adding lower (or, alternatively, upper) triangular elements, thereby making addition more computationally efficient because the matrices are sparse and symmetric. FIG. 10B shows an example of a network similarity calculation for one pair of similar fingerprints, recorded at two different times (Time 1 and Time 2), across five different stations (CCOB, CADB, CAO, CHR, CML). The similarity values for each pair are shown, together with their sum, a network similarity value. This technique is designed to be robust and flexible to changes in the network over time, as new stations come online, or old stations drop out of the network temporarily or permanently.

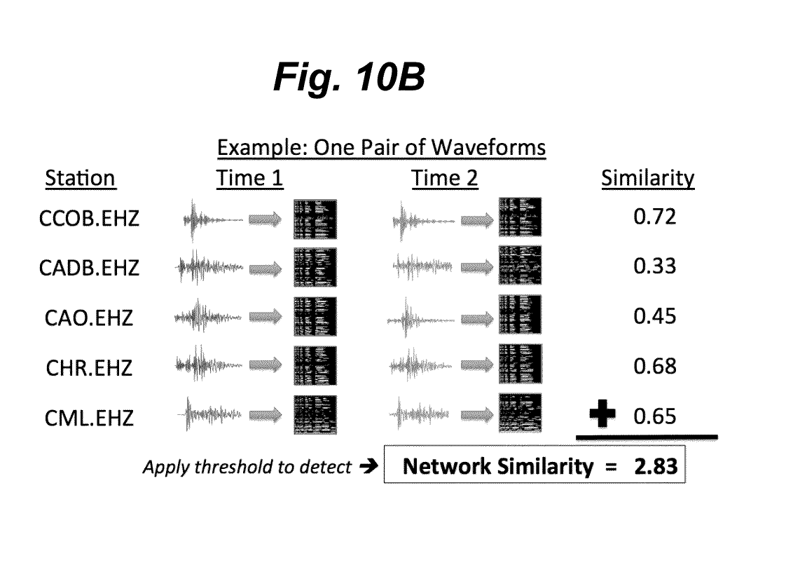

Seismic events are detected from the similarity matrix by identifying non-zero elements above a predetermined threshold. For example, FIG. 11 shows a total network similarity matrix derived from multiple stations. The diagonal clusters such as 190 represent detected seismic events. Again, the detection threshold on the network similarity matrix was set by visual inspection of waveforms recorded at all stations used for detection: most pairs above the threshold looked like earthquakes with some signal moveout, and most pairs below looked like noise. Post-processing included removal of duplicate pairs and duplicate events to convert a total network similarity matrix to a list of event detections, with a time and network similarity value for each event.

The techniques of the present invention may be implemented, for example, as a system including a seismic sensor station or network or stations in communication with a computer for processing data input to the computer or stored by the computer in accordance with the methods disclosed herein and displaying or otherwise outputting results of the processing. The present invention may also be realized as a digital storage medium tangibly embodying machine-readable instructions executable by a computer, where the instructions implement the techniques of the invention described herein.

1. A method for identifying seismic events, the method comprising:
recording by a seismic sensor continuous time series data representative of seismic activity;
generating binary fingerprints from the recorded continuous time series data, where each of the fingerprints is representative of a time window of the continuous time series data;
generating a similarity matrix from the fingerprints, where each element of the similarity matrix is a value representing similarity between a pair of fingerprints, where the value is calculated by hashing fingerprints to hash buckets in multiple hash tables and counting a fraction of the multiple hash tables containing a fingerprint match in the hash buckets;
identifying seismic events from the similarity matrix.

2. The method of claim 1, wherein generating binary fingerprints from the recorded continuous time series data comprises:
extracting a sequence of overlapping time windows from the continuous time series data representative of the seismic activity;
generating from each of the overlapping time windows a fingerprint to produce a sequence of fingerprints corresponding to the sequence of overlapping time windows.

3. The method of claim 2, wherein generating the fingerprint from each of the overlapping time windows comprises:
calculating wavelet coefficients of a spectrogram of each of the overlapping time windows,
discarding all but the k largest amplitude standardized Haar coefficients, and
mapping the coefficients to the values +1, −1, and 0, where k is a predetermined constant.

4. The method of claim 1 wherein hashing fingerprints to hash buckets in multiple hash tables comprises:
generating from each of the fingerprints a set of multiple hash signatures using multiple distinct locality-sensitive hash functions to produce a sequence of hash signature sets corresponding to the sequence of fingerprints;
selecting for each of the hash signature sets a set of corresponding hash buckets in distinct hash tables of a hash database.

5. The method of claim 1 wherein counting a fraction of the multiple hash tables containing a fingerprint match in the hash buckets comprises:
identifying the hash bucket in each hash table to which a fingerprint belongs;
counting a number of hash tables containing a matching fingerprint in the same hash bucket;
computing the ratio of the number of hash tables containing a matching fingerprint to the total number of hash tables.

6. The method of claim 1 wherein identifying seismic events from the similarity matrix comprises:
combining the similarity matrix with similarity matrices derived from continuous time series data representative of seismic activity recorded at other seismic sensors to produce a total network similarity matrix, and identifying seismic events from the total network similarity matrix by applying a detection threshold.

7. The method of claim 6 wherein the matrices are added using sparse matrix operations and only adding lower triangular elements of the matrices.

8. The method of claim 6 wherein the seismic sensor detects multiple components of a seismic waveform at a single seismic station.

9. The method of claim 6 wherein the other seismic sensors are sensors located at separate seismic stations.
